(19) United States
(12) Patent Application Publication
(10) Pub. No.: US 2011/0003043 A1
(43) Pub. Date: Jan. 6, 2011

(54) Spaghetti Noodle Packed in Retort Pouch and Method for Preparing the Same

(75) Inventors: Ma-Ri Sohn, Seoul (KR); Young-Joo Han, Seoul (KR); Youn-Sung Cho, Incheon (KR); Mi-Hee Cho, Ansan-si (KR); Kang-Pyo Lee, Seoul (KR)

Correspondence Address: ECKERT SEAMANS CHERIN & MELLOTT, 600 GRANT STREET, 44TH FLOOR, PITTSBURGH, PA, 15219, US

(73) Assignee: CJ CHEILJEDANG CORP., Seoul (KR)

(21) Appl. No.: 12/556,995

(22) Filed: Sep. 10, 2009

(30) Foreign Application Priority Data
Jul. 3, 2009 (KR) 10-2009-0060715

(51) Int. Cl. A23L 1/16; A23L 1/162; A23L 1/01; A23L 3/10

(52) U.S. Cl. 426/128; 426/302; 426/304; 426/557

(57) ABSTRACT

Disclosed herein is a method for manufacturing a spaghetti food packaged in a retort pouch, comprising: (a) boiling dry spaghetti noodles in hot water; (b) cooling and dehydrating the boiled spaghetti noodles; (c) spraying oil over the dehydrated spaghetti noodles; (d) packing the oiled spaghetti noodles in a retort pouch; and (e) subjecting the packed spaghetti noodles to multiple retort sterilization under predetermined temperature, time and pressure conditions. The spaghetti noodle product can be stored at room temperature for 12 months or longer without germ growth therein and can be instantly cooked al dente only by microwaving rather than by boiling in water.

### BACKGROUND OF THE INVENTION

1. Field of the Invention

The present invention relates to spaghetti noodle packed in retort pouch and method for preparing the same. More particularly, the present invention relates to a method for preparing a retort spaghetti noodle product, comprising: (a) boiling dry spaghetti noodles in hot water; (b) cooling and dehydrating the boiled spaghetti noodles; (c) spraying oil over the dehydrated spaghetti noodles; (d) packing the oiled spaghetti noodles in a retort pouch with a minimum gas content introduced thereinto; and (e) subjecting the packed spaghetti noodles to multiple retort sterilization procedures under predetermined temperature, time and pressure conditions. Also, the present invention is concerned with a retort spaghetti noodle product which can be stored safely at room temperature for a long time and can be instantly cooked in microwaves.

2. Description of the Related Art

Recent industrial development has compelled individuals to be busy both at home and in communities to which they belong, and single-person houses have recently increased in number. For these reasons, they tend to make their diets simple. In order to meet the convenience-directed consumer demand, the food industry has developed and commercialized a variety of instant food products which are ready to be cooked. There is an increasing demand for foods that can be instantly cooked anytime and anywhere rather than foods that require a lot of time and materials. Developed, for example, are instant spaghetti noodle products, particularly frozen noodle products and their sauces which can be cooked simply by heating for 2˜5 min in the microwave rather than by being boiling in water.

Commercially available instant spaghetti products are, for the most part, distributed in a refrigerated or frozen state. Generally, refrigerated food products suffer from the disadvantages of having a short period of distribution and being difficult to handle. In fact, they cannot be kept fresh and sharply decrease in quality if the short validity period thereof expires after being purchased. On the other hand, frozen food products require high costs for maintaining the distribution conditions therefor and show poor convenience in distribution. Further, if the condition of being frozen is not properly maintained while distributing the frozen noodle products, the moisture balance maintained within the noodles is broken so that they lose the optimal noodle taste sensation. Japanese Patent Laid-Open Unexamined Publication No. 178329, entitled “method for preparing frozen spaghetti” and Japanese Patent laid-Open Unexamined Publication No. 322712, entitled “method for preparing and packing frozen spaghetti”, disclose instant spaghetti products prepared by boiling dry spaghetti noodles in water and quickly freezing them. However, the instant spaghetti products must be distributed in a frozen state so that they are difficult to handle. Thus, they cannot be used as convenience food products which are distributable at room temperature.

Meanwhile, conventional methods for preparing noodles distributable at room temperature employ an immersion process in an acid solution to inhibit the growth of microorganisms in the noodles. For the preparation of noodle products designed to be distributed at room temperature, for example, boiled noodles are immersed in a solution of citric acid, tartaric acid, lactic acid, acetic acid or malic acid ranging in pH from 1.0 to 4.0 to decrease the pH of the noodle product. On the whole, most bacteria are inhibited from growing at a pH of 4.6 or less. However, lactic acid bacteria can propagate at less than pH 4.0. Moreover, fungi grow in a wide range of pH from 2.8 to 8.5 with spore germination at pH 3.0˜7.0. Yeast optimally grows at the pH from 4.5˜5.5 and require at least pH 3.0 to survive. However, pH 5.0˜5.3 is required for the spore germination of spore-forming bacteria such as botulinum, and the growth of vegetative cells. They cannot grow at pH 4.6 or less. Accordingly, if prepared at pH 3.7˜4.6, noodles do not allow spore-forming bacteria to grow and are not subjected to putrefaction even if spore-forming bacteria are present. Taking advantage of pH conditions inhibitory of the growth of microorganisms, the acid immersion method employs a mild thermal treatment at 100° C. or lower, but not at a high temperature for retort sterilization, to inhibit the growth of yeast, fungi and general bacteria in the noodles. In Korean Patent Laid-Open Publication No. 10-1996-20729, entitled “Method for manufacturing a pack of microwave-cookable spaghetti” and Japanese Patent Laid-Open Unexamined Publication No. 272629, entitled “Method for manufacturing boiled noodles such as spaghetti or macaroni storable for long periods of time at less than room temperature”, the acid immersion method is disclosed and applied to the preparation of spaghetti noodles. Although guaranteeing preservation for a certain period of time, the acid immersion decreases the glossy color and taste of the product and degrades the general preference for the product due to the sour flavor. Further, if a problem occurs on the process line leading to a failure in the adjustment of the pH of noodle products or if a contamination accident on the process line after a sterilization process leads to the contamination of the product with fungi or yeasts which can grow under acidic conditions, the noodle products may not be safe any more under the normal distribution conditions of room temperature.

Conventionally, an aseptic process is employed in the preparation of noodles storable at room temperature, wherein foods and packing vessels are separately sterilized and the foods are aseptically packed in the vessels which are then sealed to afford products improved in preservability. Korean Patent Laid-Open Publication No. 10-1997-32452, entitled “Method for preparing an aseptic pack of spaghetti” discloses a method in which boiled spaghetti noodles are sterilized by heating, and an aseptic process is used to pack the sterilized spaghetti noodles, along with a deoxidant, into a sterilized bag full of nitrogen gas in a cleanroom of class 100˜1000 (e.g., class 100 denotes the number of particles of size 0.5 μm or larger permitted per cubic foot of air). When prepared using the aseptic process, the food products are provided with excellent flavor, glossy color, nutrients, etc. However, facilities operating the aseptic process are very expensive and so it is economically unfavorable to apply them to small-scale production. That is, the facilities for carrying out the aseptic process are suitable for use in large-scale production of, for example, beverages and aseptically packed boiled rice. Therefore, limitations are imparted to the application of the aseptic process to the industrial production of room-temperature noodles.

Leading to the present invention, intensive and thorough research into spaghetti noodles was conducted by the present inventors with the goal being to overcome the problems encountered in the prior art. This research resulted in the finding that when prepared by the processes of boiling in water, cooling and dehydrating, oil spraying, packing in a retort pouch, and retort sterilization in a multiple step manner under controlled conditions of temperature, time and pressure, a retort spaghetti noodle product has an al dente texture and can be safely stored for a long period of time at room temperature.

### SUMMARY OF THE INVENTION

Accordingly, the present invention has been made keeping in mind the above problems occurring in the prior art, and it is an object of the present invention to provide a method for preparing a retort spaghetti noodle product, featuring a multiple retort sterilization which allows the spaghetti noodle product to be stored at room temperature for 12 months or longer without germ growth therein and to be instantly cooked al dente only by microwaving rather than by boiling in water.

In accordance with the present invention, the above object can be accomplished by a provision of a method comprising the steps of boiling dry spaghetti noodles in hot water, cooling and dehydrating the noodles, spraying oil over the noodles, packing the noodles into a retort pouch and subjecting the noodles to multiple retort sterilization.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating the processes of manufacturing a retort spaghetti noodle food.

### DESCRIPTION OF THE PREFERRED EMBODIMENTS

In accordance with an aspect thereof, the present invention pertains to a method for manufacturing an instant spaghetti food packaged in a retort pouch.

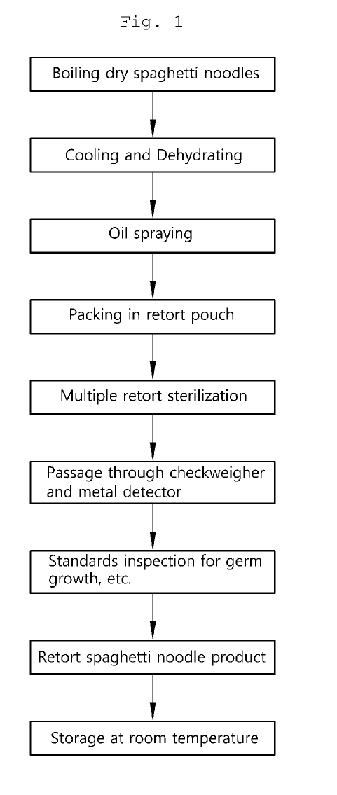

With reference to FIG. 1, processes of manufacturing a retort spaghetti noodle product in accordance with the present invention are illustrated.

As seen in this FIGURE, the method according to the present invention comprises the steps of:

(a) boiling dry spaghetti noodles in hot water;

(b) cooling and dehydrating the boiled spaghetti noodles;

(c) spraying oil over the dehydrated spaghetti noodles;

(d) packing the oiled spaghetti noodles in a retort pouch; and

(e) subjecting the retort pouch to multiple retort sterilization under predetermined temperature, time and pressure conditions.

Preferably, the method according to the present invention may further comprises conveying the sterilized pouch through a checkweigher system and a metal detector.

As long as it is edible, any noodle may be used in the present invention.

In accordance with the present invention, the step of boiling dry spaghetti noodles in hot water is very important in order to impart the noodles with optimal al dente texture. Therefore, it should be conducted under optimal conditions. In this regard, dry spaghetti noodles are boiled from once to ten times, preferably twice to five times at 80˜100° C., preferably at 90˜100° C. for 1˜20 min, preferably for 5˜10 min each time, using a boiler.

The texture sensation of spaghetti noodles depends primarily on the boiling process and the optimal taste sensation depends primarily on the retort sensation. Optimal al dente refers to a state of the pasta in which a microstructure remains without alpha structures in the center of the pasta. Particularly, spaghetti noodles cannot meet the taste of the consumer if they are not cooked al dente, that is, have no resistance when bitten. Thus, the dry spaghetti noodles are preferably boiled many times for a short period of time under accurate temperature conditions.

In the cooling and dehydrating step of (b), the boiled spaghetti noodles are cooled from one to ten times and preferably two to four times at a cold precipitation condition of 0˜25° C. and preferably 5˜20° C. for 1˜200 sec and preferably for 10˜90 sec. In order to allow for an optimal taste sensation, the noodles are preferably cooled as quickly as possible after the boiling step.

In the oil spraying step of (c), an oil spraying mixer is preferably used to spray edible oil uniformly over the noodles one to twenty times and preferably two to eight times for 10˜300 sec and preferably for 30˜180 sec. Examples of the edible oil useful in the present invention include soybean oil, corn oil, cotton seed oil, and canola oil, but are not limited thereto. Preferred is thermally resistant oil because, after the oil spraying step, the retort sterilization is conducted at high temperature and high pressure.

In the packing step of (d), the oil-coated spaghetti noodles are loaded in a predetermined amount (weight) into a retort pouch and packed in a general manner or vacuum manner using an external compression packaging system so as to increase the heat transfer rate upon the subsequent retort sterilization, that is, so as to minimize the air content within the retort pouch.

For use in the present invention, the retort pouch must be superior in thermal adhesiveness, water resistance and provision of the gas barrier. The retort pouch useful in the present invention may have a multilayer structure made of transparent oxygen-barrier materials, for example, PET12/Ny15/R-CPP70 (ZK99), but the present invention is not limited to the materials. Because the retort pouch is subjected to sterilization at 100° C. or higher using water or steam, it must have excellent thermal adhesiveness, water resistance and a gas barrier lest the layered structure or the sealed portion be interrupted or decrease in strength.

Also, the retort pouch has a gas content of 5˜50 cc and preferably 10˜30 cc after the packing step of (d).

After the packing step, the gas content of the retort pouch is closely correlated with the heat transfer rate upon the retort sterilization. More gas induces a smaller heat transfer rate, leading to a decrease in sterilization effect. In addition, excess gas in the pouch gives rise to an increase in internal pressure upon sterilization, thus imparting a load to the sealed portion of the pouch. Further, the oxygen present in the gas causes the food within the pouch to degrade. Consequently, the spaghetti noodles are packed in the retort pouch in such a manner as to minimize the gas content thereof to increase the heat transfer rate upon sterilization.

As for the retort sterilization of (e), it is preferably conducted in a multiple step manner under the conditions of predetermined temperature, time and pressure because a great temperature change may be likely to induce a change in the degree of gelatinization and interrupt the texture of noodles, reducing the taste. The retort pouch containing the spaghetti noodles therein is primarily heated at 50˜120° C. and preferably at 85˜100° C. for 1˜60 min and preferably for 5˜20 min and actually sterilized at 100 ˜150° C. and preferably at 110˜130° C. for 1˜60 min and preferably for 10˜30 min under a pressure of 0.1˜5.0 kgf/cm² and preferably 1.3˜2.0 kgf/cm², followed by cooling at a pressure which is higher than that used for the actual sterilization by 0.01˜3.0 kgf/cm² and preferably by 0.1˜1.0 kgf/cm² so as to prevent the deformation of the product container.

A sharp temperature increase upon the sterilization of the spaghetti noodles is highly apt to break the texture of the noodles and degrade the taste sensation. For this reason, the retort pouch is preheated to 85˜100° C. to maintain the noodles at 70˜85° C. After the temperature of the noodles is slowly elevated through the preheating process, the retort pouch is further heated to 110˜130° C. for a period of time determined according to the kind and amount of the noodles. Preferably, the pressure condition is controlled to cause a sharp pressure change upon cooling after the actual sterilization.

This retort sterilization process guarantees that there is the retort noodle products do not degrade in quality. Since the internal pressure of the pouch is lower than the retort pressure in the initial stage of the retort sterilization, the vessel is under compression. On the other hand, since the internal pressure is far higher than the retort pressure upon the sterilization and cooling steps, the vessel is under tension. In order to prevent the pressure unbalance, the conditions of heating rate, cooling rate and pressure must be controlled. If the difference between internal and external pressure of the pouch upon the sterilization of retort foods is greater than 0.2 kgf/cm², the pouch ruptures and damages the food content. Therefore, it is important to maintain the retort pressure at the same level as the internal pressure of the pouch upon sterilization.

In accordance with another aspect thereof, the present invention provides a retort spaghetti noodle produt with an al dente texture, which can be stored at room temperature for 12 months or longer and be instantly cooked.

Data obtained through assays for physicochemical properties, e.g., pH and water activity (Aw), and for germ growth demonstrated that the retort spaghetti noodle product according to the present invention was very safe in terms of preservative ability under room temperature distribution conditions, without apparent quality degradation nor germ growth.

In addition, the retort spaghetti noodle product according to the present invention was determined as able to be safely stored for about 58 weeks (405 days, ca. 13 months) at 25° C. That is, the retort spaghetti noodle product prepared by using the method of the present invention can be distributed at room temperature for 12 months or longer.

Moreover, sensory tests and tests for physical properties indicate that the retort spaghetti noodle product prepared according to the method of the present invention is far superior in taste and physical properties to other room temperature noodle prepared by manufactured using a conventional acid immersion process.

In addition to being commercially distributed for 12 months or longer thanks to the multiple-type retort sterilization for inhibiting the growth of microorganisms, the retort spaghetti noodle food of the present invention can be instantly cooked, with a sauce put thereon, by microwaving rather than by boiling in water. The instant food will satisfy the taste of the consumers.

Prepared by the method comprising the steps of boiling dry spaghetti noodles in hot water, cooling and dehydrating the noodles, spraying oil over the noodles, packing the noodles in a pouch and subjecting the noodles to multiple-type retort sterilization, as described above, the retort spaghetti noodle product according to the present invention can be stored at room temperature for 12 months or longer and can be instantly cooked along with sauce in a microwave.

A better understanding of the present invention may be obtained through the following examples which are set forth to illustrate, but are not to be construed as limiting the present invention.

### Example 1

### Preparation of Retort Spaghetti Noodle Food

A retort spaghetti noodle product which can be safely stored at room temperature for a long period of time was prepared according to the method of the present invention.

15 kg of dry spaghetti noodles was boiled three times at 100° C. for 160 sec for each time in a boiler. The dry noodles were sequentially introduced at regular intervals of 10 min into three separate boilers.

Immediately after the third boiling, the noodles were cooled at 10° C. for 10 sec and then for 70 sec. In order to impart the noodles with optimal taste sensation, quick cooling was conducted as soon after the boiling process as possible.

After the cooling process, the dehydrated noodles were uniformly coated with oil by spraying corn oil five times for 70 sec using an oil spraying mixer. Because it is relatively resistant to heat, corn oil was employed in consideration of the retort sterilization.

Using an automatic loader, the noodles were introduced in an amount of 130 g into a retort pouch which was then sealed with a minimal gas content (about up to 30 cc) therein so as to increase the heat transfer rate upon the subsequent retort sterilization. The retort pouch had a multilayer structure made of transparent oxygen-barrier materials, that is, PET12/Ny15/R-CPP70 (ZK99). Because it underwent a sterilization process at 100° C. or higher in water or steam, the retort pouch should be superior in thermal adhesiveness, water resistance and gas barrier lest the layered structure or the sealed portion be interrupted or decrease in strength. The retort pouches were loaded with a space therebetween on a cart and introduced into a retort sterilization system.

Because a sharp temperature change is very apt to induce a change in the degree of gelatinization and destroy the texture of the noodles, leading to the degradation of taste, the retort sterilization was conducted in a multiple step manner under the condition set at predetermined a temperature, time and pressure. Following a pre-heating process at 95° C. for 15 min, the retort pouch was heated to 121.1° C. and maintained at the temperature for 20 min under a pressure of 1.5 kgf/cm² to conduct sterilization (F₀ value of 5˜8). Upon cooling, the pressure was set to be higher than that upon the sterilization by 0.2 kgf/cm² so as to prevent the vessel from being deformed.

After the completion of retort sterilization, the pouches were dried to remove the moisture from the surface thereof. Products containing impurities and metals were selected out by passage through a checkweigher and a metal detector. Additionally, tests were conducted to examine whether the products met predetermined quality requirements. Also, the pouches were found to be negative to germ growth. As a result, retort spaghetti noodle food products which could be safely stored at room temperature were prepared.

### Experimental Example 1

### Accelerated Experiments of the Retort Spaghetti Noodle Product for Physicochemical Properties and Germ Growth

Results obtained through the accelerated experiments of the retort spaghetti noodle products prepared in Example 1 for physicochemical properties and germ growth are summarized in Table 1.

A germ growth experiment was performed according to the Food Code. In an incubation test under a warm condition, 20 specimens were stored for 10 days in an incubated set at 35±1° C. and left for one day at room temperature. During the incubation, if the vessel/package was monitored to be inflated or leaked, it was determined to be positive for germ growth.

Only after the food product was judged to be negative to the incubation test was it subjected to the following germ test. After being completely cleansed with sanitary cotton immersed in 70% alcohol, 20 vessels were opened. 25 g of the content was withdrawn from each of the vessels and suspended in 225 mL of phosphate buffered saline. 1 mL of the suspension was diluted in 9 mL of phosphate buffered saline and well mixed. The dilution was inoculated in an amount of 1 mL in quintuplicate into a thioglycolic acid medium, followed by incubation at 35° C. for 48±3 hrs. If germ growth was observed, the product was determined to be positive.

The retort spaghetti noodle products prepared according to the present invention were stored in 25° C., 35° C. and 45° C. incubators and assayed at regular intervals of two weeks for change in physicochemical properties such as pH and water activity and for germ growth. They were not observed to undergo quality degradation with negative germ growth. Therefore, the products according to the present invention can be distributed at room temperature for a long period of time with high safety.

TABLE 1

| | Storage | | Water | Germ |
|---|---|---|---|---|
| | Temp. | pH | Activity(Aw) | Growth |
| Control | | 6.50 | 0.99 | Negative |
| Week 2 | 25° C. | 6.48 | 0.98 | Negative |
| | 35° C. | 6.42 | 0.97 | Negative |
| | 45° C. | 6.45 | 0.98 | Negative |
| Week 4 | 25° C. | 6.48 | 0.98 | Negative |
| | 35° C. | 6.45 | 0.98 | Negative |
| | 45° C. | 6.30 | 0.97 | Negative |
| Week 6 | 25° C. | 6.49 | 0.97 | Negative |
| | 35° C. | 6.43 | 0.97 | Negative |
| | 45° C. | 6.44 | 0.97 | Negative |
| Week 8 | 25° C. | 6.47 | 0.98 | Negative |
| | 35° C. | 6.48 | 0.97 | Negative |
| | 45° C. | 6.38 | 0.98 | Negative |
| Week 10 | 25° C. | 6.45 | 0.98 | Negative |
| | 35° C. | 6.45 | 0.96 | Negative |
| | 45° C. | 6.36 | 0.97 | Negative |
| Week 12 | 25° C. | 6.44 | 0.98 | Negative |
| | 35° C. | 6.40 | 0.97 | Negative |
| | 45° C. | 6.32 | 0.96 | Negative |

### Experimental Example 2

### Determination of Distribution Validity Term of Retort Spaghetti Noodle Product

An experiment was performed to determine when the validity of the retort spaghetti noodle product prepared in Example 1 expired.

An accelerated experiment was performed (validity term calculated with Q₁₀ based on the Arrhenius equation). The retort spaghetti noodle products manufactured in a large scale were incubated at 25° C., 35° C. and 45° C. for a predetermined period of time in incubators during which they were monitored for physicochemical properties. Of them, pH was found to have the highest correlation with taste preference in the sensory test. Hence, pH values were adopted as a quality index for determining the term of distribution validity. A sensory quality limit value of the product was set (2.5 points/5) and applied to a regression equation to obtain values of the corresponding items in question. From each temperature constant of the change reactions of the values, Q₁₀ values and activations energy therefor were calculated. In addition, the time point when the product value ended was applied to the results of the 45° C. sensory test to determine the term of distribution validity.

As a result, the retort spaghetti noodle products prepared according to the method of the present invention was determined to have a distribution validity term of about 58 weeks (405 days, ca. 13 months) at 25° C. Therefore, the retort spaghetti noodle products according to the present invention can be distributed at room temperature for 12 months or longer.

### Experimental Example 3

### Sensory Test of Retort Spaghetti Noodle Product

Consumer survey was performed to examine the sensory quality attributes and product properties of the retort spaghetti noodle foods manufactured according to the method of the present invention and the results are summarized in Table 2, below.

A sensory test was conducted with 47 housewives who were 25˜49 years old and lived in Seoul or the nearby surrounding area. The sensory evaluation was based on a 5-point hedonic scale through Mean/ANOVA/Open question analysis. A commercially available retort spaghetti food product was used as a control. As shown in Table 2, the retort spaghetti noodle product manufactured according to the present invention was superior to the control in general taste sensation and other properties.

TABLE 2

| | | Retort Spaghetti |
|---|---|---|
| | | Product of the |
| | Control | Invention |
| General Satisfaction | 3.05 | 3.63 |
| General Taste | 3.11 | 3.51 |
| Appearance | 3.15 | 3.66 |
| Taste Sensation | 2.77 | 3.45 |
| Worth | 3.10 | 3.90 |

### INDUSTRIAL APPLICABILITY

prepared by the method comprising the steps of boiling dry spaghetti noodles in hot water, cooling and dehydrating the noodles, spraying oil over the noodles, packing the noodles in a pouch and subjecting the noodles to multiple-type retort sterilization, as described hitherto, the retort spaghetti noodle product according to the present invention can be distributed at room temperature for 12 months or longer and can be instantly cooked along with sauce in a microwave rather than by being boiled in water.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for preparing a spaghetti noodle product packaged in a retort pouch, comprising the steps of:
(a) boiling dry spaghetti noodles in hot water;
(b) cooling and dehydrating the boiled spaghetti noodles;
(c) spraying oil over the dehydrated spaghetti noodles;
(d) packing the oiled spaghetti noodles in a retort pouch; and
(e) subjecting the retort pouch to multiple retort sterilization under predetermined temperature, time and pressure conditions.

2. The method according to claim 1, wherein the boiling step of (a) is carried out by boiling the dry spaghetti noodles two to five times at 90˜100° C. for 5˜10 min each time.

3. The method according to claim 1, wherein the cooling and dehydrating step of (b) comprises cooling two or four times at 5˜20° C. for 10˜90 sec each time.

4. The method according to claim 1, wherein the spraying step of (c) is carried out by uniformly coating the noodles with edible oil two to eight times for 30˜180 sec each time.

5. The method according to claim 1, wherein the oiled spaghetti noodles are packed into the retort pouch with a gas content of 10˜30 cc in the packing step of (d).

6. The method according to claim 1, wherein the retort sterilization of (e) is carried out in such a multiple step process that the pouch is firstly preheated at 85˜100° C. for 5˜20 min and then is secondary sterilized at 110˜130° C. for 10˜30 min under a pressure of 1.3˜2.0 kgf/cm², followed by cooling at a pressure higher than the pressure of the secondary sterilization by 0.1˜1.0 kgf/cm².

7. A retort spaghetti noodle product with al dente texture sensation, manufactured using the method according to claim 1.

8. A retort spaghetti noodle product with al dente texture sensation, manufactured using the method according to claim 2.

9. A retort spaghetti noodle product with al dente texture sensation, manufactured using the method according to claim 3.

10. A retort spaghetti noodle product with al dente texture sensation, manufactured using the method according to claim 4.

11. A retort spaghetti noodle product with al dente texture sensation, manufactured using the method according to claim 5.

12. A retort spaghetti noodle product with al dente texture sensation, manufactured using the method according to claim 6.
